(19) United States
(12) Patent Application Publication
(10) Pub. No.: US 2015/0061519 A1
(43) Pub. Date: Mar. 5, 2015

(54) Control Apparatus, Control System, and Control Method

(71) Applicant: Toshiba Lighting & Technology Corporation, Yokosuka-shi (JP)

(72) Inventors: Hiroshi Akahoshi, Yokosuka-shi (JP); Masayuki Tanaka, Yokosuka-shi (JP); Toshihiko Sasai, Yokosuka-shi (JP); Toru Ishikita, Yokosuka-shi (JP)

(73) Assignee: TOSHIBA LIGHTING & TECHNOLOGY CORPORATION, Yokosuka-shi (JP)

(21) Appl. No.: 14/219,715

(22) Filed: Mar. 19, 2014

(30) Foreign Application Priority Data
Aug. 30, 2013 (JP) 2013-180603

(51) Int. Cl. H05B 33/08

(52) U.S. Cl. CPC H05B 33/0809
USPC 315/200 R

(57) ABSTRACT

According to one embodiment, there is provided a control apparatus including a receiving section, a specifying section, and control sections. The receiving section receives a control signal. The specifying section specifies a control system corresponding to the control signal received by the receiving section. The control sections derive, according to the control system specified by the specifying section, control designated by the control signal received by the receiving section, and apply the derived control to a lighting device.

### CROSS-REFERENCE TO RELATED APPLICATIONS

This application is based upon and claims the benefit of priorities from Japanese Patent Application No. 2013-180603 filed on Aug. 30, 2013; the entire contents of which are incorporated herein by reference.

### FIELD

Embodiments described herein relate to a control apparatus, a control system, and a control method.

### BACKGROUND

In recent years, there is known a luminaire control system that makes it possible to individually control a plurality of luminaires. The luminaire control system includes a host apparatus that transmits a control signal for instructing control of extinction, lighting, a change of illuminance, and the like to the luminaires and a luminaire including a power supply device that controls a lighting device such as an LED (Light Emitting Diode) according to the control signal received from the host apparatus. However, the control signal transmitted to the luminaires by the host apparatus is different for each of types of luminaire control systems. Therefore, the conventional luminaire needs a power supply device corresponding to the control signal different for each of the types of the luminaire control systems. Therefore, the same model of the conventional luminaire cannot be adapted to a plurality of types of luminaire control systems.

### BRIEF DESCRIPTION OF THE DRAWINGS

FIG. 1 is a diagram showing a configuration example of a lighting system according to a first embodiment;

FIG. 2 is a diagram for explaining a configuration example of a luminaire according to the first embodiment;

FIGS. 3A to 3C are diagrams for explaining types of control signals;

FIGS. 4D and 4E are diagrams for explaining examples of rectifying circuits;

FIG. 5 is a diagram for explaining a configuration example of an interface circuit according to the first embodiment;

FIG. 6 is a diagram for explaining functional components included in a microcomputer according to the first embodiment;

FIG. 7 is a flowchart for explaining a procedure of processing executed by the luminaire;

FIG. 8 is a diagram for explaining a first modification of the interface circuit;

FIG. 9 is a diagram for explaining a second modification of the interface circuit;

FIG. 10 is a diagram for explaining a third modification of the interface circuit;

FIG. 11 is a diagram showing waveforms generated by delaying a rising edge of a control signal subjected to half-wave rectification;

FIG. 12 is a diagram for explaining a first modification of the microcomputer;

FIG. 13 is a diagram for explaining a modification of the functional components included in the microcomputer;

FIG. 14 is a diagram showing an example of a correspondence between pin switches and a system to be specified;

FIG. 15 is a diagram for explaining a second modification of the microcomputer; and

FIG. 16 is a diagram showing an example of a correspondence between a value of a voltage applied to the pin switch and a system to be specified.

### DETAILED DESCRIPTION

It is an object of the present invention to provide a luminaire adapted to a plurality of types of luminaire control systems.

In general, according to one embodiment, there is provided a power-supply control section 10 including a receiving section 16, a specifying section 17, and control sections 18 to 20. The receiving section 16 receives a control signal. The specifying section 17 specifies a control system corresponding to the control signal received by the receiving section 16. The control sections 18 to 20 derive, according to the control system specified by the specifying section 17, control designated by the control signal received by the receiving section 16, and apply the derived control to an LED 9.

The power-supply control section 10 according to the embodiment may further include a rectifying section 15. The rectifying section 15 may generate a first signal obtained by subjecting the control signal to full-wave rectification and a second signal obtained by subjecting the control signal to half-wave rectification. The receiving section 16 may output one of the first signal and the second signal generated by the rectifying section 15 to the control sections 18 to 20.

The power-supply control section 10 according to the embodiment may further include a plurality of input sections 25a to 25d. A predetermined voltage may be applied to the input sections 25a to 25d. The specifying section 17 may specify, according to a value of the voltage applied to the input sections 25a to 25d or a combination of the input sections 25a to 25d applied with the voltage, the control system corresponding to the control signal received by the receiving section 16.

In the power-supply control section 10 according to the embodiment, the specifying section 17 may include a specifying mode for specifying a control system and specify, only when the specifying mode is effective, a system that uses the control signal received by the receiving section 16.

According to another embodiment, there is provided a lighting system 1 including a power-supply control section 10 and a host apparatus 2. The host apparatus 2 includes a transmitting section configured to transmit a control signal to the power-supply control section 10. The power-supply control section 10 includes a receiving section 16, a specifying section 17, and control sections 18 to 20. The receiving section 16 receives a control signal of a luminaire. The specifying section 17 specifies a control system corresponding to the control signal received by the receiving section 16. The control sections 18 to 20 derive, according to the control system specified by the specifying section 17, control designated by the control signal received by the receiving section 16, and apply the derived control to the LED 9.

In the lighting system 1 according to the embodiment, the transmitting section may output a system signal indicating the control system corresponding to the control signal at predetermined timing. The specifying section 17 may specify the control system indicated by the system signal output from the transmitting section.

The lighting system 1 and the power-supply control section 10 according to embodiments are explained below with reference to the drawings. In the embodiments, the same components are denoted by the same reference numerals and signs and redundant explanation of the components is omitted.

### First Embodiment

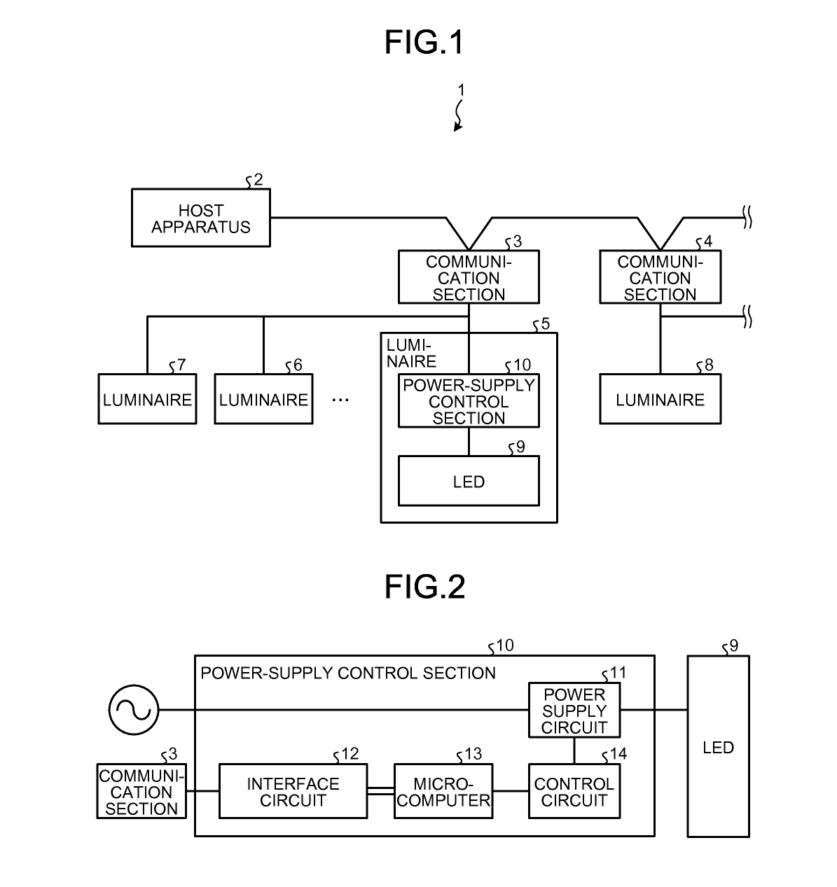

First, a lighting system according to a first embodiment is explained with reference to FIGS. 1 to 7.

Example of the Configuration of the Lighting System

FIG. 1 is a diagram showing a configuration example of the lighting system according to the first embodiment. A lighting system 1 shown in FIG. 1 is a system that realizes control and monitoring of luminaires set in a home, an office, and the like. For example, in some case, the lighting system 1 acquires, with a sensor or the like, information concerning an environment in which luminaires are set such as T/Flecs (registered trademark) and performs control of the luminaires.

A host apparatus 2 and a plurality of communication sections 3 and 4 are connected to the lighting system 1 shown in FIG. 1. The communication section 3 is connected to a plurality of luminaires 5 to 7. The communication section 4 is connected to a luminaire 8. The luminaire 5 includes an LED 9, which is a lighting section configured to light an arbitrary place, and a power-supply control section 10 configured to perform control of the LED 9. The communication section 4 has a function same as a function of the communication section 3. Explanation of the communication section 4 is omitted below. The luminaires 6 to 8 have a function same as a function of the luminaire 5. Explanation of the luminaires 6 to 8 is omitted below. The numbers of the communication sections 3 and 4 and the number of the luminaires 5 to 8 included in the lighting system 1 shown in FIG. 1 are only an example and can be changed as appropriate according to the configuration of the lighting system 1.

The host apparatus 2 outputs a control signal for instructing control of the luminaires to the communication section 3 and the communication section 4. For example, the host apparatus 2 outputs a control signal for instructing arbitrary control such as lighting, extinction, a change of illuminance, or a change of a color of light of the LED 9 included in the luminaire 5 to the communication section 3. The host apparatus 2 can use a control system of an arbitrary type in order to perform the control of the luminaires. For example, the host apparatus 2 outputs control signals corresponding to various control systems such as T/Flecs (registered trademark), DALI (Digital Addressable Lighting Interface), and PWM (Pulse Width Modulation) in order to control the luminaires.

The host apparatus 2 outputs a different control signal for each of the control systems. For example, the host apparatus 2 outputs, according to types of the control systems, a control signal indicating control content in positions of a rising edge and a falling edge of a voltage, a control signal indicating control content according to whether a falling edge is present or a rising edge is present when a pulse is divided at a fixed cycle, a control signal indicating control content with modulation of pulse width, and the like. The host apparatus 2 outputs, according to the types of the control systems, a control signal in which a voltage changes in a range of both positive and negative poles and a control signal in which a voltage changes in one of positive and negative ranges.

A detailed example is explained. If a control signal of T/Flecs is output, the host apparatus 2 outputs a double pole signal in which a voltage changes in a range of both positive and negative poles. The double pole signal is a control signal indicating control content in positions of a rising edge and a falling edge of the voltage. If the host apparatus 2 outputs a control signal of DALI, the host apparatus 2 outputs a single pole signal in which a voltage changes in one of positive and negative ranges. The single pole signal is a control signal indicating control content according to whether a falling edge is present or a rising edge is present when a pulse is divided at a fixed cycle. If the host apparatus 2 outputs a control signal using PWM, the host apparatus 2 outputs a single pole signal, which is a control signal indicating control content with modulation of pulse width.

The communication section 3 is a relay device configured to relay communication between the host apparatus 2 and the luminaires 5 to 7. For example, when the communication section 3 receives a control signal indicating control of the LED 9 from the host apparatus 2, the communication section 3 outputs the received control signal to the luminaire 5 including the LED 9. If the communication section 3 receives a response signal indicating that the control of the LED 9 is finished and a notification signal indicating a state of the LED 9 from the luminaire 5, the communication section 3 transmits the received response signal and the received notification signal to the host apparatus 2. As a result, the host apparatus 2 can confirm that the control of the LED 9 is completed and a dimming state of the LED 9.

The luminaire 5 is a luminaire installed in, for example, a home or an office. The luminaire 5 includes the LED 9, which is replaceable light and the power-supply control section 10 configured to perform the control of the LED 9. Like the conventional luminaire, the luminaire 5 is a unit of setting or replacement when the lighting system 1 is set or updated. The conventional luminaire is adapted to only a control signal of a control system of a specific type. Therefore, the conventional luminaire needs to have a different power-supply control section for each of control systems of the host apparatus 2.

On the other hand, the power-supply control section 10 included in the luminaire 5 executes processing explained below. First, the power-supply control section 10 receives a control signal output by the host apparatus 2 from the communication section 3. The power-supply control section 10 specifies a control system corresponding to the received control signal. For example, the power-supply control section 10 specifies the control system corresponding to the received control signal on the basis of a change in the potential of the received control signal, a waveform of a pulse included in the control signal, a cycle of the pulse, and the like. The power-supply control section 10 derives control content indicated by the received control signal according to the specified control system and executes the control of the derived content on the LED 9.

Therefore, the same luminaire 5 can be adapted to a type of the control system of the host apparatus 2 irrespective of the type. As a result, for example, when the control system of the host apparatus 2 is changed, the lighting system 1 can control the luminaires 5 to 8 using a new control system even if the luminaires 5 to 8 are not replaced with luminaires corresponding to the new control system. When any one of the luminaires is broken, in the lighting system 1, the luminaire 5 only has to be set instead of the broken luminaire even if the same luminaire is prepared. As a result, in the lighting system 1, it is possible to flexibly perform setting and replacement of the luminaires 5 to 8.

Example of the Configuration of the Luminaire 5

A configuration example of the power-supply control section 10 is explained below with reference to FIG. 2. FIG. 2 is a diagram for explaining a configuration example of the luminaire according to the first embodiment. As shown in FIG. 2, the power-supply control section 10 includes a power supply circuit 11, an interface circuit 12, a microcomputer 13, and a control circuit 14. A power supply of electric power supplied to the LED 9 is connected to the power supply circuit 11.

Example of the Configuration of the Power Supply Circuit 11

The power supply circuit 11 is a circuit configured to change, according to control by the control circuit 14, electric power supplied to the LED 9. For example, the power supply circuit 11 receives supply of electric power from the power supply. When the power supply circuit 11 receives a control signal from the control circuit 14, the power supply circuit 11 performs, according to the received control signal, for example, control of an amount of the electric power, which is supplied from the power supply, supplied to the LED 9 to perform lighting, extinction, a change of illuminance, a change of a color of light, and the like of the LED 9.

Example of the Configuration of the Interface Circuit 12

The interface circuit 12 includes a rectifying circuit configured to rectify a control signal received from the communication section 3 and outputs the control signal rectified using the rectifying circuit to the microcomputer 13. Specifically, the interface circuit 12 rectifies the control signal to a single pole side to enable the microcomputer 13 to identify control content.

Since it is unknown whether the host apparatus 2 outputs a double pole signal or outputs a single pole signal, the interface circuit 12 needs to appropriately rectify both of the double pole signal and the single pole signal. However, if the control signal received from the communication section 3 is simply subjected to full-wave rectification or half-wave rectification, the interface circuit 12 cannot perform appropriate rectification depending on a type of the control signal.

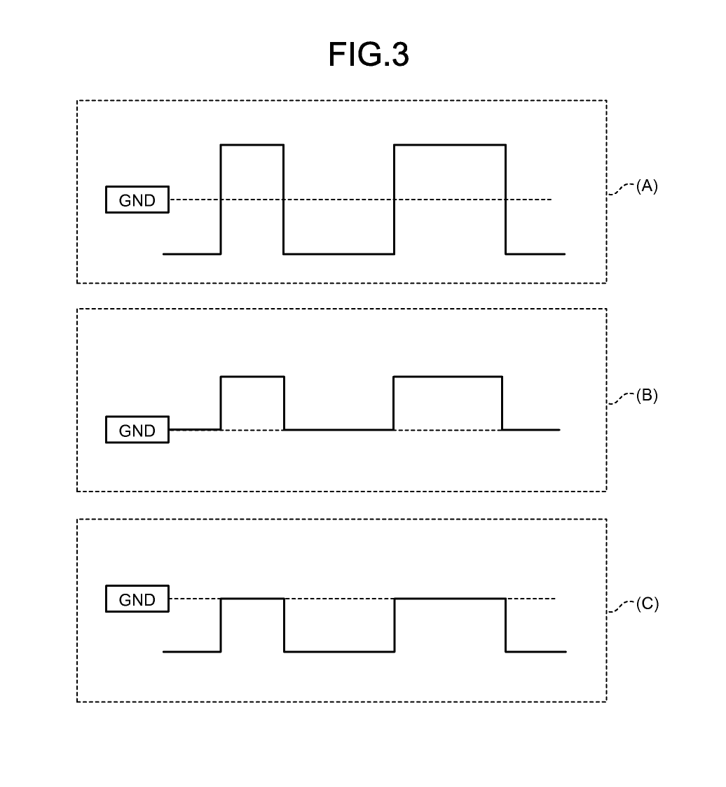

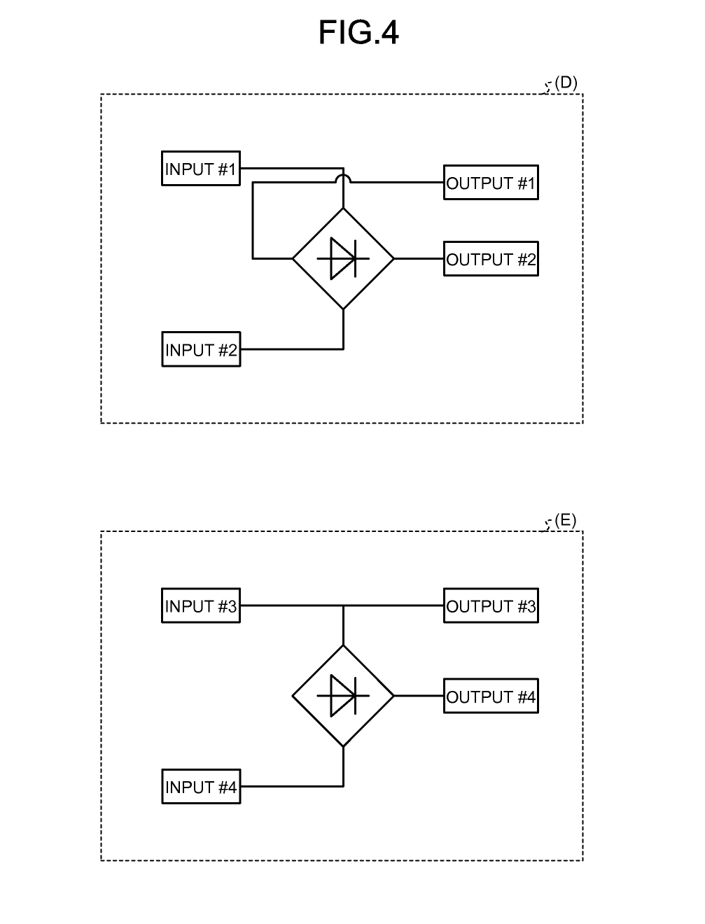

A correspondence between a type of a control signal and a rectifying method is explained with reference to FIGS. 3 and 4. First, examples of control signals output by the host apparatus 2 is explained with reference to FIGS. 3A to 3C. FIGS. 3A to 3C are diagrams for explaining types of control signals. In FIGS. 3A to 3C, a plurality of examples of control signals output by the host apparatus 2 are shown.

For example, in some case, the host apparatus 2 outputs, as a control signal, a double pole signal in which a voltage changes in a range of both positive and negative poles as shown in FIG. 3A. In some case, the host apparatus 2 outputs, as a control signal, a control signal in which a voltage changes in a positive range as shown in FIG. 3B or a single pole signal in which a voltage changes in a negative range.

Examples of rectifying circuits configured to rectify a control signal are explained with reference to FIGS. 4D and 4E. FIGS. 4D and 4E are diagrams for explaining examples of rectifying circuits. In the examples shown in FIGS. 4D and 4E, an example of a rectifying circuit configured to subject a control signal to full-wave rectification is shown in FIG. 4D and an example of a rectifying circuit configured to subject a control signal to half-wave rectification is shown in FIG. 4E. In FIG. 4D and 4E, the rectifying circuits are indicated by a sign of a diode and a diamond figure surrounding the sign. The rectifying circuits are not limited to a bridge type and may be rectifying circuits including, for example transformers. In the following explanation and in the figures, a rectifying circuit is indicated by a sign same as the sign shown in FIGS. 4D and 4E.

For example, if the single pole signal shown in FIGS. 3B and 3C is rectified, it is unknown from which side of a positive pole side and a negative pole side a signal is output depending on a direction of a wire. Therefore, the interface circuit 12 inputs the positive pole side of the control signal to an input #1 of the circuit shown in FIG. 4D and inputs the negative pole side of the control signal to an input #2 of the circuit. As a result, the interface circuit 12 can output the control signal rectified to the positive pole side from an output #1 or an output #2.

However, if the double pole signal shown in FIG. 3A is input to the circuit shown in FIG. 4D, signals on respective pole sides of the double pole signal are aggregated on the positive pole side. Therefore, the interface circuit 12 outputs a direct-current voltage from the output #1 or the output #2. In such a case, the microcomputer 13 cannot identify control content from the control signal. Therefore, the interface circuit 12 cannot perform appropriate rectification with the circuit shown in FIG. 4D.

For example, if the double pole signal shown in FIG. 3A is rectified, the interface circuit 12 inputs the control signal to the input #1 and the input #2 of the circuit shown in FIG. 4E. As a result, the interface circuit 12 can output a control signal rectified to the single pole side from the output #1 and the output #2. However, if the single pole signal shown in FIG. 3B or 3C is input to the circuit shown in FIG. 4E, the interface circuit 12 cannot output the single pole signal on the positive pole side or the single pole signal on the negative pole side. As a result, in some case, the microcomputer 13 cannot identify control content from the control signal. Therefore, the interface circuit 12 cannot perform appropriate rectification with the circuit shown in FIG. 4E.

The interface circuit 12 generates a signal obtained by subjecting the control signal to full-wave rectification and a signal obtained by subjecting the control signal to half-wave rectification. The interface circuit 12 outputs the generated signals to the microcomputer 13. As a result, the microcomputer 13 can identify control content indicated by the control signal using at least one of the signals output from the interface circuit 12.

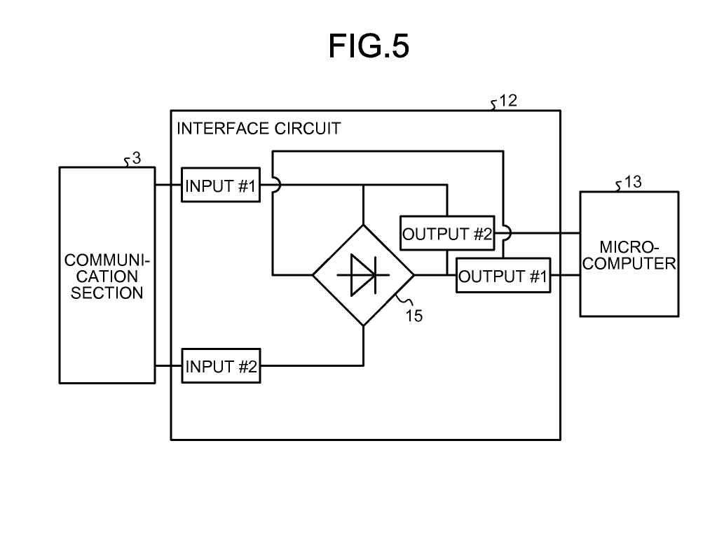

A configuration example of the interface circuit 12 is explained with reference to FIG. 5. FIG. 5 is a diagram for explaining a configuration example of the interface circuit according to the first embodiment. In the example shown in FIG. 5, the interface circuit 12 includes the rectifying section 15 including the respective pole sides of the control signal as the input #1 and the input #2 and including the output #1 obtained by combining the output on the positive pole side and the output on the negative pole side and the output #2 obtained by combining the input #1 and the output on the negative pole side.

The rectifying section 15 is, for example, a rectifying circuit realized by a circuit including a diode and a transformer connected in a bridge type. The rectifying circuit 15 is indicated by a sign of a diode and a diamond figure surrounding the sign. The output #1 and the output #2 of the rectifying section 15 are connected to the microcomputer 13.

The interface circuit 12 outputs a signal obtained by subjecting the control signal to full-wave rectification to the microcomputer 13 from the output #1 of the rectifying section 15 and outputs a signal obtained by subjecting the control signal to half-wave rectification to the microcomputer 13 from the output #2 of the rectifying section 15. Therefore, for example, if the control signal received from the communication section 3 is a single pole signal on the positive pole side or the negative pole side, the interface circuit 12 can output a signal for enabling the microcomputer 13 to identify control content to the output #1 or the output #2 according to the pole of the input single pole signal. If the control signal received from the communication section 3 is a double pole signal, the interface circuit 12 can output the signal for enabling the microcomputer 13 to identify control content from the output #2.

Example of the Configuration of the Microcomputer 13

Referring back to FIG. 2, the microcomputer 13 is a micro controller that executes a computer program prepared in advance to display a predetermined function. The microcomputer 13 is realized by an integrated circuit such as an ASIC (Application Specific Integrated Circuit) or an FPGA (Field Programmable Gate Array). The microcomputer 13 may be realized by, for example, a CPU (Central Processing Unit) or an MPU (Micro Processing Unit).

The microcomputer 13 executes the computer program prepared in advance to display a function explained below. First, the microcomputer 13 receives a signal rectified by the interface circuit 12. In such a case, the microcomputer 13 specifies a control system of the host apparatus 2 using the rectified signal. That is, the microcomputer 13 specifies a control system corresponding to a control signal received by the power-supply control section 10. The microcomputer 13 derives, according to the specified control system, control content indicated by the received signal and outputs an execution instruction for the derived control content to the control circuit 14.

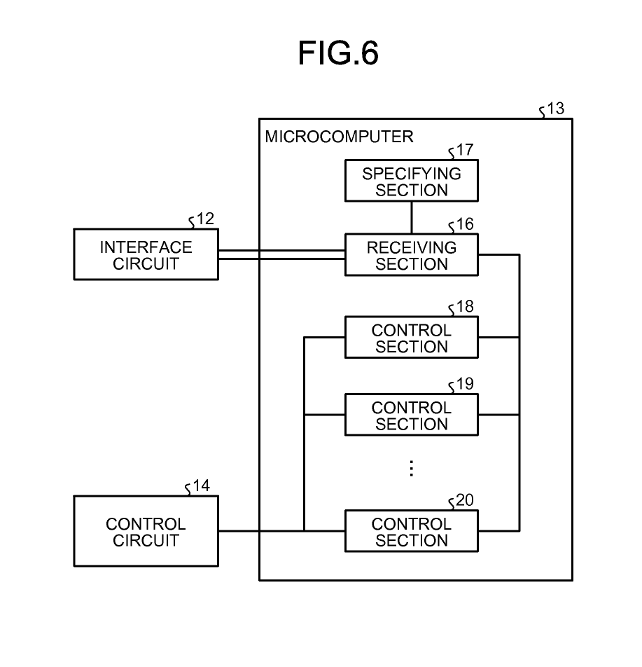

An example of functional components included in the microcomputer 13 is explained with reference to FIG. 6. FIG. 6 is a diagram for explaining functional components included in the microcomputer according to the first embodiment. In the example shown in FIG. 6, the microcomputer 13 includes a receiving section 16, a specifying section 17, and a plurality of control sections 18 to 20. In the example shown in FIG. 6, although not shown in the figure, the microcomputer 13 may further include a control section similar to the control section 18.

The receiving section 16 receives a control signal from the interface circuit 12. For example, the receiving section 16 receives a signal obtained by rectifying the control signal from the interface circuit 12. In such a case, the receiving section 16 selects, out of the received signals, a signal suitable for identifying control content indicated by the control signal.

If the receiving section 16 does not receive designation of a control section from the specifying section 17, for example, if the receiving section 16 receives the control signal for the first time after the luminaire 5 is set, the receiving section 16 outputs the signals received from the interface circuit 12 to the specifying section 17 for a predetermined time interval. If the receiving section 16 receives designation of a control section to be an output designation of a signal among the control sections 18 to 20 from the specifying section 17, the receiving section 16 transmits signals received from the interface circuit 12 thereafter to the control section designated by the specifying section 17.

As processing for selecting a signal suitable for identifying control content indicated by the control signal among the signals received from the interface circuit 12 by the receiving section 16, the receiving section 16 executes processing explained below. For example, if the receiving section 16 receives a double pole signal when the interface circuit 12 includes the configuration shown in FIG. 5, the receiving section 16 receives a direct-current voltage from the output #1 and receives a rectified signal from the output #2. If the receiving section 16 receives a single pole signal when the interface circuit 12 includes the configuration shown in FIG. 5, the receiving section 16 receives, according to a pole direction of the single pole signal, rectified signals from the output #2 or both of the output #1 and the output #2. Therefore, the receiving section 16 only has to select a signal including a pulse out of the signal received from the output #1 and the signal received from the output #2.

The luminaire 5, to which a double pole signal of T/Flecs is input from the host apparatus 2, outputs a response via a signal line same as a signal line of the input signal. If such processing is executed, the balance of pole directions in the double pole signal is lost. Therefore, as a result of the double pole signal being input when the interface circuit 12 includes the configuration shown in FIG. 5, if a plurality of signals including pulses are received from the interface circuit 12, the receiving section 16 only has to select a signal having a predominant voltage, that is, a signal with which control content is more easily identified and perform identification of the control content. By executing such processing, the receiving section 16 uses a signal more suitable for specifying the control content. Therefore, it is possible reduce the influence of noise in a connection line for connecting the host apparatus 2 and the luminaire 5.

The specifying section 17 specifies a control system corresponding to the control signal received by the luminaire 5. For example, the specifying section 17 receives the signal selected by the receiving section 16 for a predetermined time interval. The specifying section 17 specifies, on the basis of a change in the potential of the received signal, a waveform of the pulse included in the signal, a cycle of the pulse, and the like, a control system corresponding to the control signal received by the luminaire 5.

As an example of processing executed by the specifying section 17, an example of processing for determining whether the control system corresponding to the control signal received by the luminaire 5 is T/Flecs, DALI, or PWM is explained below. Embodiments are not limited to this. The specifying section 17 only has to specify, according to a characteristic of the control signal, the control system corresponding to the control signal received by the luminaire 5.

First, the specifying section 17 determines whether the control signal received by the luminaire 5 is a double pole signal or a single pole signal. For example, when the interface circuit 12 includes the configuration shown in FIG. 5, if a signal on the output #1 side is a direct-current voltage and a signal on the output #2 side is a rectified signal, the specifying section 17 determines that the control signal is a double pole signal. If the specifying section 17 determines that the control signal is the double pole signal, the specifying section 17 determines that the control system corresponding to the control signal received by the luminaire 5 is T/Flecs.

On the other hand, when the interface circuit 12 includes the configuration shown in FIG. 5, if the signal on the output #2 side is a rectified signal or both the signals on the output #1 side and the output #2 side are rectified signals, the specifying section 17 determines that the control signal is a single pole signal. If the specifying section 17 determines that the control signal is the single pole signal, the specifying section 17 determines cycles of a pulse included in the signal.

If the determined cycle of the pulse is equal to or smaller than a predetermined threshold, for example, equal to or smaller than 10 milliseconds, the specifying section 17 determines that the control system corresponding to the control signal received by the luminaire 5 is DALI. On the other hand, if the determined cycle of the pulse is larger than the predetermined threshold, the specifying section 17 determines whether the cycle of the pulse is fixed. If the specifying section 17 determines that the cycle of the pulse is fixed, the specifying section 17 determines that the control system corresponding to the control signal received by the luminaire 5 is PWM.

DALI indicates control content according to whether a rising edge of the pulse is included or a falling edge of the pulse is included when the control signal is divided by a predetermined time interval (the cycle of the pulse). Therefore, depending on the time interval of the control signal used in specifying the control content and the cycle of the pulse, the cycle of the pulse cannot be accurately calculated. Therefore, if the specifying section 17 determines that the cycle of the pulse is not fixed, the specifying section 17 determines that the control system corresponding to the control signal received by the luminaire 5 is DALI.

The specifying section 17 derives the control content from the control signal according to the specified control system and designates, to the receiving section 16, a control section that applies control of the derived content to the LED 9, that is, a control section corresponding to the specified control system. For example, the specifying section 17 stores in advance that the control section 18 corresponds to T/Flecs, the control section 19 correspond to DALI, and the control section 20 corresponds to PWM. If the specified control system is T/Flecs, the specifying section 17 notifies the receiving section 16 of the control section 18. If the specified control system is DALI, the specifying section 17 notifies the receiving section 16 of the control section 19. If the specified control system is PWM, the specifying section 17 notifies the receiving section 16 of the control section 20.

The control sections 18 to 20 derive control content from the control signal respectively according to different control systems and execute control of the derived content on the LED 9. For example, if the control section 18 is the control section corresponding to T/Flecs and receives a rectified control signal, the control section 18 derives control content indicated by the received control signal according to rules of T/Flecs and instructs the control circuit 14 to reflect the derived control content. If the control section 19 is the control section corresponding to DALI and receives a rectified control signal, the control section 19 derives control content indicated by the received control signal according to rules of DALI and instructs the control circuit 14 to reflect the derived control content. If the control section 20 is the control section corresponding to PWM and receives a rectified control signal, the control section 20 derives control content indicated by the received control signal according to rules of PWM and instructs the control circuit 14 to reflect the derived control content.

Example of the Configuration of the Control Circuit 14

Referring back to FIG. 2, the control circuit 14 reflects the control content specified from the control signal by the microcomputer 13 on the LED 9. For example, if the control circuit 14 receives control content such as lighting, extinction, a change of illuminance, or a change of a color of light of the LED 9, the control circuit 14 reflects the control content on the LED 9 by controlling the power supply circuit 11 to reflect the received control content.

Example of a Procedure of Processing by the Luminaire 5

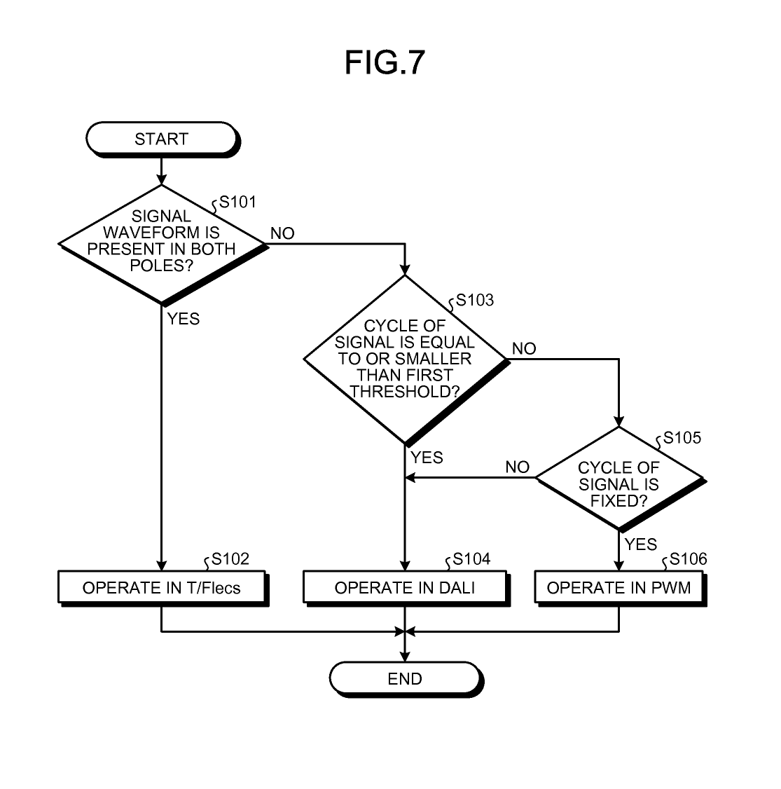

A flow of processing for specifying, from a control signal received by the luminaire 5, a flow of processing for specifying a control system corresponding to the control signal is explained with reference to FIG. 7. FIG. 7 is a flowchart for explaining a procedure of processing executed by the luminaire according to the first embodiment. As shown in FIG. 7, when the luminaire 5 receives a control signal, the luminaire 5 determines whether a signal waveform of the received control signal is present in both poles (step S101).

If the signal waveform of the received control signal is present in both the poles (step S101: Yes), the luminaire 5 controls the LED 9 with T/Flecs (step S102) and ends the processing. On the other hand, if the signal waveform of the received control signal is absent in both the poles (step S101: No), the luminaire 5 determines whether a cycle of the control signal is equal to or smaller than a predetermined threshold (step S103). If the luminaire 5 determines that the cycle of the control signal is equal to or smaller than the predetermined threshold (step S103: Yes), the luminaire 5 controls the LED 9 with DALI (step S104) and ends the processing.

On the other hand, if the luminaire 5 determines that the cycle of the control signal is larger than the predetermined threshold (step S103: No), the luminaire 5 determines whether the cycle of the control signal is fixed (step S105). If the luminaire 5 determines that the cycle of the control signal is fixed (step S105: Yes), the luminaire 5 controls the LED 9 with PWM (step S106) and ends the processing. On the other hand, if the luminaire 5 determines that the cycle of the control signal is not fixed (step S105: No), the luminaire 5 controls the LED 9 with DALI (step S104) and ends the processing.

Effects of the First Embodiment

As explained above, the power-supply control section 10 includes the receiving section 16 configured to receive a control signal, the specifying section 17 configured to specify a control system corresponding to the control signal received by the receiving section 16, and the control sections 18 to 20 configured to derive control indicated by the control signal according to the control system specified by the specifying section 17 and apply the derived control to a lighting device. Therefore, the power-supply control section 10 can be adapted to a plurality of kinds of control systems.

The power-supply control section 10 includes the rectifying section 15 configured to generate a first signal obtained by subjecting the control signal to full-wave rectification and a second signal obtained by subjecting the control signal to half-wave rectification. The receiving section 16 outputs one of the first signal and the second signal generated by the rectifying section 15 to the control sections 18 to 20. Therefore, the power-supply control section 10 can rectify a double pole signal and a single pole signal using a single circuit.

The lighting system 1 includes the power-supply control section 10 and the host apparatus 2 that outputs a control signal for a lighting device to the power-supply control section 10. The power-supply control section 10 includes the receiving section 16 configured to receive a control signal, the specifying section 17 configured to specify a control system corresponding to the control signal received by the receiving section 16, and the control sections 18 to 20 configured to derive control indicated by the control signal according to the control system specified by the specifying section 17 and apply the derived control to a lighting device. Therefore, the lighting system 1 can perform control of the lighting device according to an arbitrary control system.

### Other Embodiments

The lighting system 1 explained above may be implemented in various different forms other than the embodiment. Therefore, various modifications of the lighting system 1 are explained below.

First Modification of the Interface Circuit

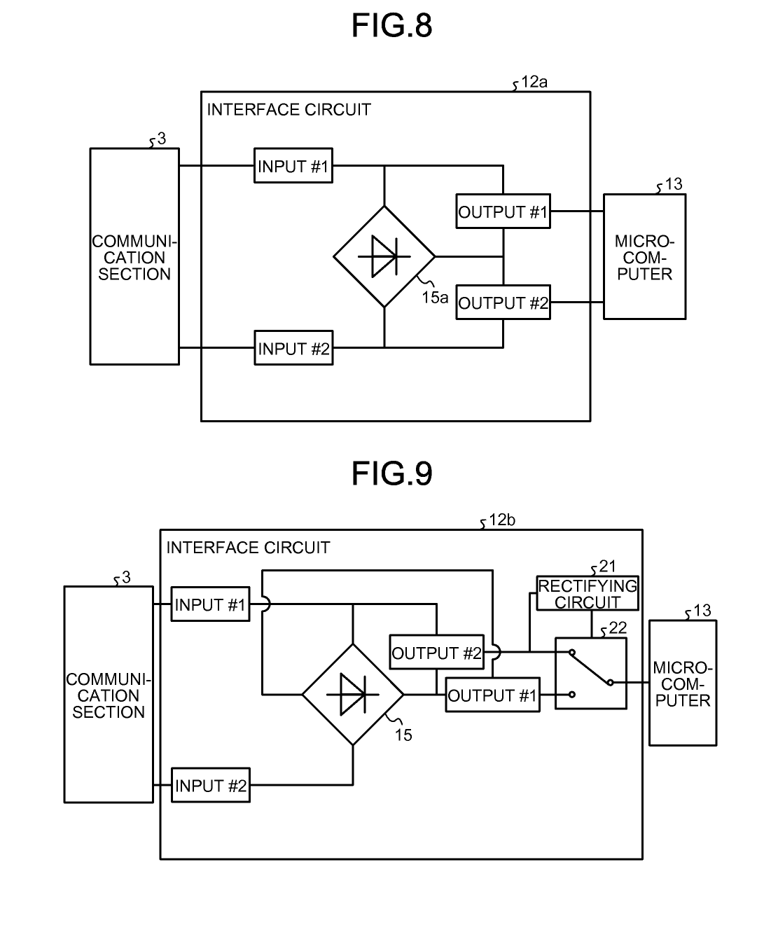

The configuration example of the interface circuit 12 shown in FIG. 5 is only an example. The interface circuit 12 may include other configuration examples. For example, the interface circuit 12 may subject respective pole sides of a control signal to half-wave rectification and output signals subjected to half-wave rectification to the microcomputer 13. FIG. 8 is a diagram for explaining a first modification of the interface circuit according to the first embodiment. For example, in the example shown in FIG. 8, as another configuration example of the interface circuit 12 and the rectifying section 15, the configuration of an interface circuit 12a and a rectifying section 15a is shown.

For example, the rectifying section 15a includes respective pole sides of the control signal as the input #1 and the input #2 and includes the output #1 obtained by combining the input #1 and the output on the negative pole side and the output #2 obtained by combining the input #2 and the output on the negative pole side. If a double pole signal is input from the communication section 3, the interface circuit 12a output a signal for enabling the microcomputer 13 to identify control content from each of the output #1 and output #2. If a single pole signal is input from the communication section 3, the interface circuit 12a outputs the signal for enabling the microcomputer 13 to identify control content from the output #1 or the output #2 according to whether the single pole signal is a single pole signal on the positive pole side or a single pole signal on the negative pole side.

In such a case, if the interface circuit 12a receives a double pole signal, the receiving section 16 shown in FIG. 6 receives rectified signals from both of the output #1 and the output #2. If the interface circuit 12a receives a single pole signal, the receiving section 16 receives a rectified signal from the output #1 or the output #2 according to a pole direction of the single pole signal. Therefore, the receiving section 16 only has to select a signal including a pulse out of the signal received from the output #1 and the signal received from the output #2.

If the signals on the output #1 side and the output #2 side are rectified signals, the specifying section 17 determines that the control signal is a double pole signal. If the signal on the output #1 side or the output #2 side is a rectified signal, the specifying section 17 determines that the control signal is a single pole signal. The specifying section 17 only has to specify a control method corresponding to the control signal by executing the processing explained above.

Second Modification of the Interface Circuit

The interface circuit 12 outputs a pair of the signal obtained by subjecting the control signal to full-wave rectification and the signal obtained by subjecting the control signal to half-wave rectification to the microcomputer 13. However, embodiments are not limited to this. For example, the interface circuit 12 may select a signal more suitable for specifying control content out of the rectified signals and output only the selected signal to the microcomputer 13. In this way, connections of the interface circuit 12 and the microcomputer 13 may be integrated as one system.

FIG. 9 is a diagram for explaining a second modification of the interface circuit according to the first embodiment. In the example shown in FIG. 9, an interface circuit 12b includes the rectifying section 15 same as the rectifying section 15 of the interface circuit 12. The interface circuit 12b includes a rectifying circuit 21 configured to rectify a signal of the output #2 and a switch 22.

The rectifying circuit 21 is a rectifying circuit configured to rectify a signal output from the output #2 of the rectifying section 15. For example, if a signal is output from the output #2, the rectifying circuit 21 applies direct-current potential to the switch 22. If a signal is not output from the output #1, the rectifying circuit 21 does not apply a voltage to the switch 22.

The switch 22 is a switch configured to receive the output #1 and the output #2 as inputs and output one of the inputs to the microcomputer 13 according to an output of the rectifying circuit 21. Specifically, if a direct-current voltage is applied from the rectifying circuit 21, the switch 22 outputs, to the microcomputer 13, a signal output from the output #2 included in the rectifying section 15. If a direct-current voltage is not applied from the rectifying circuit 21, the switch 22 outputs, to the microcomputer 13, a signal output from the output #1 included in the rectifying section 15.

According to such an operation, the interface circuit 12b can output, to the microcomputer 13, a signal suitable for specifying control content among signals out the outputs included in the rectifying section 15. As a result, the microcomputer 13 can perform the control of the LED 9 using the signal output by the interface circuit 12b without performing signal selection processing. If the luminaire 5 includes the interface circuit 12b, the microcomputer 13 only has to acquire a control signal directly from the communication section 3 and execute processing for specifying a control system using the acquired control signal.

As explained above, the interface circuit 12b output a signal more suitable for specifying a control system among signals obtained by rectifying the control signal. Therefore, the power-supply control section 10 including the interface circuit 12b can reduce a load of processing executed by the microcomputer 13.

Third Modification of the Interface Circuit

The interface circuit 12a shown in FIG. 8 outputs the two signals obtained by the rectifying section 15a subjecting the control signal to half-wave rectification concerning the respective poles. If the outputs of the rectifying section 15a are simply combined in order to integrate the signals output from the interface circuit 12a to the microcomputer 13 in one system, when a double pole signal is input to the interface circuit 12a, a direct-current voltage is output. Therefore, the interface circuit 12a may add a rising edge delay to the output #1 and the output #2 of the rectifying section 15a, integrate the output #1 and the output #2 added with the raising edge delay as one system, and output the signals to the microcomputer 13.

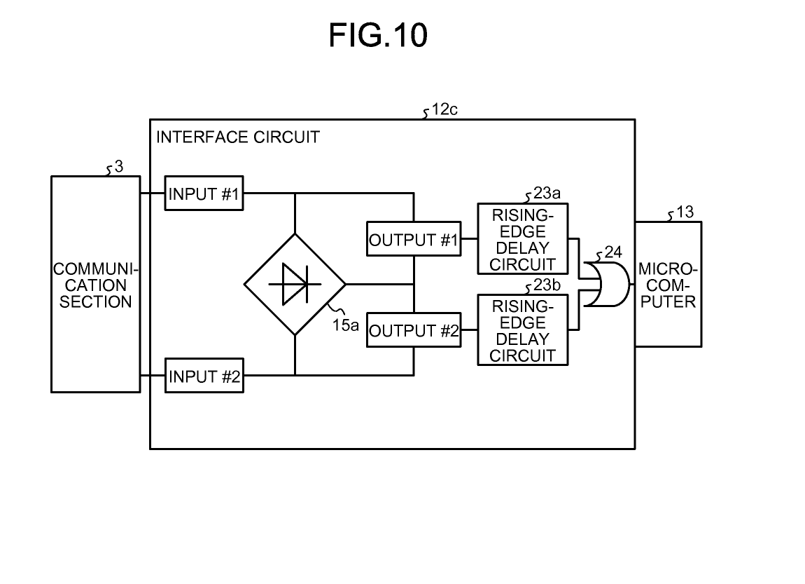

FIG. 10 is a diagram for explaining a third modification of the interface circuit according to the first embodiment. As shown in FIG. 10, an interface circuit 12c includes the rectifying section 15a, a rising-edge delay circuit 23a, a rising-edge delay circuit 23b, and a combining section 24. The rising-edge delay circuit 23a is a circuit configured to delay rising edge timing of a signal output from the output #1 of the rectifying section 15a and is, for example, a CR circuit configured to generate a time constant and delay a rising edge. The rising-edge delay circuit 23b is a circuit configured to delay rising edge timing of a signal output from the output #2 of the rectifying section 15a and is, for example, a CR circuit same as the rising-edge delay circuit 23a. The combining section 24 combines the signals output by the rising-edge delay circuit 23a and 23b and outputs a combined signal to the microcomputer 13.

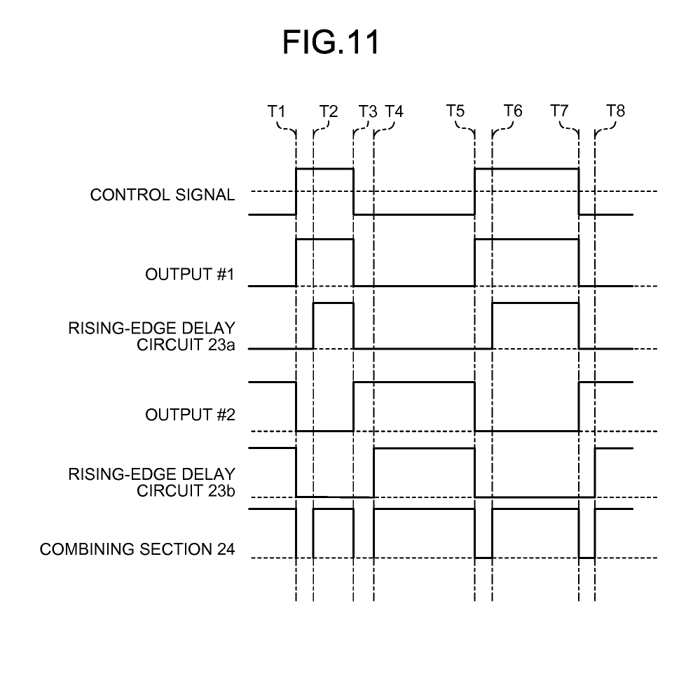

Waveforms of signals output by the interface circuit 12c are explained with reference to FIG. 11. FIG. 11 is a diagram showing waveforms generated by delaying a rising edge of a control signal subjected to half-wave rectification. In FIG. 11, waveforms of a control signal input to the rectifying section 15a, the output #1, a signal output by the rising-edge delay circuit 23a, the output #2, a signal output by the rising-edge delay circuit 23b, and a signal output by the combining section 24 are shown. In the example shown in FIG. 11, ground potential is indicated by a dotted line and rising edge and falling edge timings of the signals are indicated by alternate long and short dash lines.

Among timings T1 to T8 shown in FIG. 11, the timings T1, T3, T5, and T7 are rising edge and falling edge timings of the control signal. The timings T2, T4, T6, and T8 correspond to the timings T1, T3, T5, and T7 delayed by the rising-edge delay circuits 23a and 23b.

For example, in the example shown in FIG. 11, a control signal, which is a double pole signal, is input to the rectifying section 15a. The potential of the control signal input to the rectifying section 15a rises to “High” at the timing T1 and falls to “Low” at the timing T3. The potential of the control signal rises to “High” at the timing T5 and falls to “Low” at the timing T7.

If such a control signal is input, a signal obtained by rectifying a positive pole side of the control signal is output from the output #1. As a result, the rising-edge delay circuit 23a outputs the rectified signal, which is a signal, the potential of which rises to “High” at the timing T2, falls to “Low” at the timing T3, rises to “High” at the timing T6, and falls to “Low” at the timing T7.

A signal obtained by rectifying a negative pole side of the control signal is output from the output #2. Specifically, a signal, the potential of which falls to “Low” at the timing T1, rises to “High” at the timing T3, falls to “Low” at the timing T5, and rises to “High” at the timing T7, is output from the output #2. Therefore, the rising-edge delay circuit 23b outputs a signal, the potential of which falls to “Low” at the timing T1, rises to “High” at the timing T4, falls to “Low” at the timing T5, and rises to “High” at the timing T8.

As a result, the combining section 24 outputs a signal, the potential of which falls to “Low” at the timing T1, rises to “High” at the timing T2, falls to “Low” at the timing T3, and rises to “High” at the timing T4. The combining section 24 outputs a signal, the potential of which falls to “Low” at the timing T5, rises to “High” at the timing T6, falls to “Low” at the timing T7, and rises to “High” at the timing T8.

As explained above, if the output #1 and the output #2 of the rectifying section 15a are simply combined, the interface circuit 12c outputs a direct-current voltage. The microcomputer 13 cannot specify control content. However, the combining section 24 generates a signal obtained by delaying the rising edges of the signals of the output #1 and the output #2 and outputs the signal to the microcomputer 13. As a result, the combining section 24 outputs a signal, the potential of which changes at timing when the potential of the control signal changes. Therefore, it is possible to output, in one system, a signal with which control content indicated by the control signal can be specified.

That is, in the signal output by the combining section 24, the potential changes at timing same as timing when the potential of the control signal changes. Therefore, the microcomputer 13 can specify the frequency and the like of the control signal from the signal output by the combining section 24. As a result, the microcomputer 13 can specify a control system and control content corresponding to the control signal from the signal output in the one system. For example, the microcomputer 13 only has to specify falling edge timing of the signal output by the interface circuit 12c and specify control content indicated by a control signal according to the specified falling edge timing.

Execution Timing of Specifying Processing

The power-supply control section 10 specifies, for example, during setting, a control system corresponding to the received control signal, derives control from the control signal according to the specified control system, and executes the derived control on the LED 9. However, embodiments are not limited to this.

For example, the power-supply control section 10 may specify a control system corresponding to the received control signal at a predetermined time interval. Specifically, the receiving section 16 may output, at the predetermined time interval, signal received from the interface circuit 12 to the specifying section 17 by the predetermined time interval to update a control section at an output destination of the signals at the predetermined time interval. By executing such processing, even if the control system of the host apparatus 2 is changed, the power-supply control section 10 can appropriately perform control of the lighting device.

If noise occurs on a communication line between the host apparatus 2 and the power-supply control section 10, since a waveform of the control signal changes, it is likely that the power-supply control section 10 cannot specify an appropriate control system. Therefore, the host apparatus 2 may output a system signal indicating a control system at predetermined timing such as setting time of the lighting system 1. The luminaire 5 may perform control of content indicated by the control signal on the basis of rules of the control system indicated by the received system signal.

For example, at the setting time of the lighting system 1, the host apparatus 2 outputs a system signal indicating that the control system is T/Flecs to the luminaire 5. In such a case, the specifying section 17 included in the microcomputer 13 of the power-supply control section 10 may determine that the control system is T/Flecs and notify the receiving section 16 of the control section 18 that performs the control of the LED 9 according to rules of T/Flecs. By executing such processing, the lighting system 1 can prevent the power-supply control section 10 from erroneously specifying a control system.

Execution Mode of the Specifying Processing

The power-supply control section 10 may include a specifying mode for executing the specifying processing for a control system. For example, the receiving section 16 of the microcomputer 13 includes a normal operation mode and a specifying mode as operation modes. The normal operation mode is a mode for outputting a received signal to a control section designated by the specifying section 17. The specifying mode is a mode for outputting the received signal to the specifying section 17.

At the setting time of the luminaire 5, for example, if the receiving section 16 receives a predetermined signal from the host apparatus 2 or if the receiving section 16 is instructed to operate in the specifying mode by a user via a button set in the luminaire 5 or a remote controller of the luminaire 5, the receiving section 16 operates in the specifying mode and outputs the received signal to the specifying section 17. If the receiving section 16 receives designation of a control section from the specifying section 17, the receiving section 16 shifts to the normal operation mode. And the receiving section outputs a signal received thereafter to the designated control section. On the other hand, in a mode other than the specifying mode, the receiving section 16 does not output the received signal to the specifying section 17. By executing such processing, the power-supply control section 10 is prevented from erroneously specifying a control system. Therefore, it is possible to appropriately control the lighting device.

Modifications of the Microcomputer 13

The microcomputer 13 specifies a control system corresponding to the received control signal using the received control signal. However, embodiments are not limited to this. For example, taking into account failsafe, the microcomputer 13 may include pin switches, zip switches, or the like and derive control indicated by the control signal according to a control system designated by the user operating the pin switches or the zip switches.

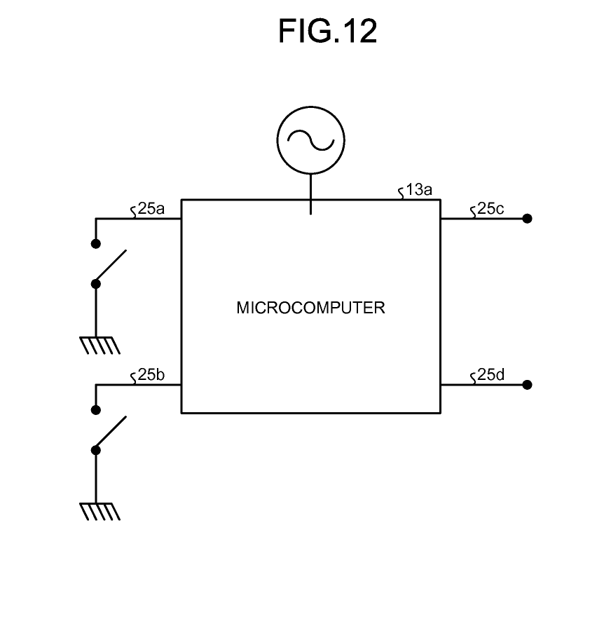

FIG. 12 is a diagram for explaining a first modification of the microcomputer according to the first embodiment. In the example shown in FIG. 12, a microcomputer 13a includes a plurality of pin switches 25a to 25d. Although not shown in FIG. 12, like the microcomputer 13 shown in FIG. 2, the microcomputer 13a is connected to the interface circuit 12 and the control circuit 14.

The pin switches 25 and 25b are connected to the ground via a switch. It is possible to switch ON and OFF of the switch and switch potentials applied to the pin switches 25a and 25b to “High (a floating voltage)” or “Low (ground potential)”. The user switches the switch and changes a combination of potentials applied to the pin switches 25a and 25b to designate a type of a control system to the microcomputer 13a. As a result, the microcomputer 13a derives control content from a control signal according to the control system of the type designated by the user. Therefore, it is possible to appropriately control the lighting device.

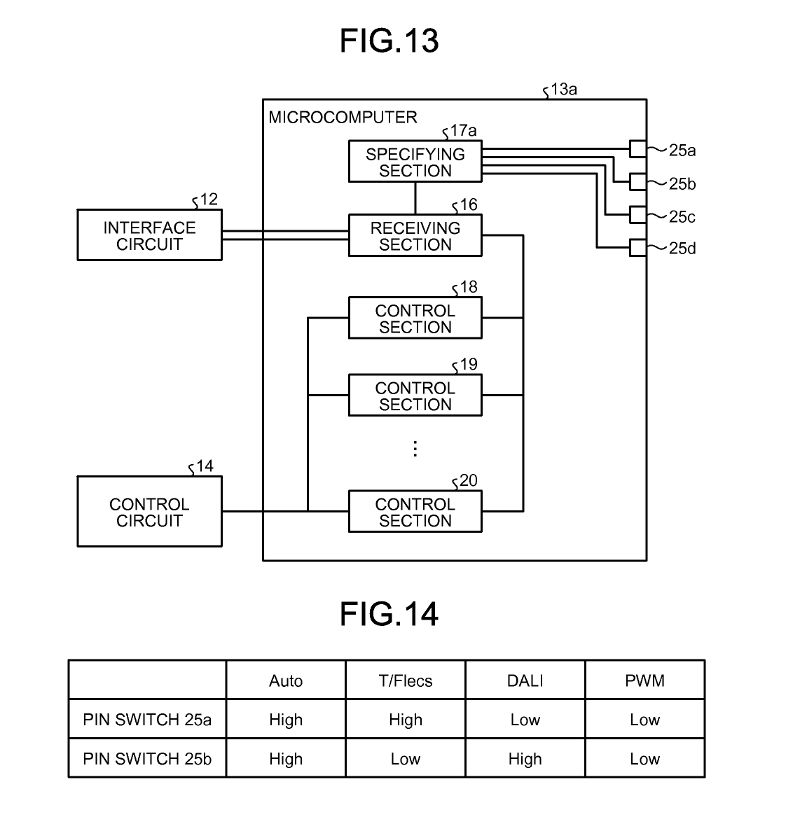

An example of functional components of the microcomputer 13a is explained with reference to FIG. 13. FIG. 13 is a diagram for explaining a modification of the functional components included in the microcomputer according to the first embodiment. As shown in FIG. 13, the microcomputer 13a includes a specifying section 17a connected to the pin switches 25a to 25d. The specifying section 17a specifies a type of a control system of the host apparatus 2 according to a combination of input sections applied with a voltage among the pin switches 25a to 25d and notifies the receiving section 16 of a control section corresponding to the specified control system.

FIG. 14 is a diagram showing an example of a correspondence between the pin switches and a control system to be specified. For example, if both the potentials of the pin switches 25a and 25b are “High”, like the specifying section 17, the specifying section 17a specifies a control system from a waveform and the like of a control signal. If the potential of the pin switch 25a is “High” and the potential of the pin switch 25b is “Low”, the specifying section 17a specifies that the control system is T/Flecs. If the potential of the pin switch 25a is “Low” and the potential of the pin switch 25b is “High”, the specifying section 17a specifies that the control system is DALI. If both the potentials of the pin switches 25a and 25b are “Low”, the specifying section 17a specifies that the control system is PWM.

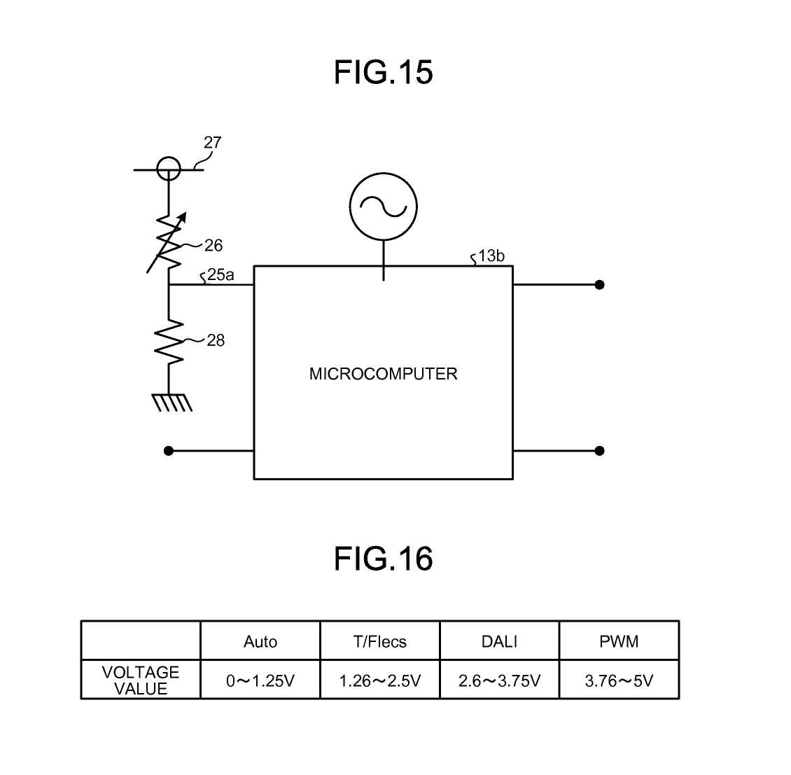

The microcomputer 13a may specify a control system according to a value of a voltage applied to the pin switches rather than a combination of the pin switches applied with a voltage. For example, FIG. 15 is a diagram for explaining a second modification of the microcomputer according to the first embodiment. In the example shown in FIG. 15, fixed potential 27 is supplied to a microcomputer 13b via the pin switch 25a and a variable resistor 26. A slider for changing a resistance value of the variable resistor 26 is set on the surface of the luminaire 5 to allow the user to easily operate the slider. The microcomputer 13b is connected to the ground via the pin switch 25a and a resistor 28.

The user changes the resistance value of the variable resistor 26 to change potential applied to the pin switch 25a to designate a type of a control system to the microcomputer 13b. As a result, even if there are many types of control systems to be specified, the microcomputer 13b does not have to increase the number of the pin switches 25a to 25d.

FIG. 16 is a diagram showing an example of a correspondence between a value of a voltage applied to the pin switch and a control system to be specified. For example, if a value of a voltage applied to the pin switch 25a is “0 to 1.25 V”, like the specifying section 17, the microcomputer 13b specifies a control system from a waveform and the like of a control signal. If the value of the voltage applied to the pin switch 25a is “1.26 to 2.5 V”, the microcomputer 13b specifies that the control system is T/Flecs. If the value of the voltage applied to the pin switch 25a is “2.6 to 3.75 V”, the microcomputer 13b specifies that the control system is DALI. If the value of the voltage applied to the pin switch 25a is “3.76 to 5 V”, the microcomputer 13b specifies that the control system is PWM.

As explained above, the microcomputers 13a and 13b include the plurality of pin switches 25a and 25d and specify a control system according to a value of a voltage applied to the pin switches 25a to 25d or a combination of the pin switches 25a to 25d applied with the voltage. Therefore, the power-supply control section 10 derives control from a control signal according to a control system of a type designated by the user and executes the derived control. Therefore, it is possible to prevent malfunction and appropriately perform control of the lighting device.

In the above explanation, the type of the control system specified according to the value of the voltage applied to the pin switches 25a to 25d or the combination of the pin switches 25a to 25d applied with the voltage is only an example. That is, the microcomputers 13a and 13b may specify a control system of an arbitrary type besides T/Flecs, DALI, and PWM.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A control apparatus comprising:
a receiving section configured to receive a control signal;
a specifying section configured to specify a control system corresponding to the control signal received by the receiving section; and
control sections configured to derive, according to the control system specified by the specifying section, control designated by the control signal received by the receiving section, and apply the derived control to a lighting device.

2. The apparatus according to claim 1 further comprising:
a rectifying section configured to generate a first signal obtained by subjecting the control signal to full-wave rectification and a second signal obtained by subjecting the control signal to half-wave rectification, wherein
the receiving section outputs one of the first signal and the second signal generated by the rectifying section to the control sections.

3. The apparatus according to claim 1, further comprising:
a plurality of input sections to which a predetermined voltage is applied, wherein
the specifying section specifies, according to a value of the voltage applied to the input sections or a combination of the input sections applied with the voltage, the control system corresponding to the control signal received by the receiving section.

4. The apparatus according to claim 1, wherein the specifying section includes a specifying mode for specifying a control system and specifies, only when the specifying mode is effective, a control system corresponding to the control signal received by the receiving section.

5. A control system comprising:
a control apparatus; and
a host apparatus,
the host apparatus including a transmitting section configured to transmit a control signal to the control apparatus, and
the control apparatus including:
a receiving section configured to receive a control signal;
a specifying section configured to specify a control system corresponding to the control signal received by the receiving section; and
control sections configured to derive, according to the control system specified by the specifying section, control designated by the control signal received by the receiving section, and apply the derived control to a lighting device.

6. The system according to claim 5, wherein
the transmitting section outputs a system signal indicating the control system corresponding to the control signal; and
the specifying section specifies the control system indicated by the system signal output from the transmitting section.

7. The system according to claim 5, wherein
the control apparatus further includes a rectifying section configured to generate a first signal obtained by subjecting the control signal to full-wave rectification and a second signal obtained by subjecting the control signal to half-wave rectification, and
the receiving section outputs one of the first signal and the second signal generated by the rectifying section suitable for deriving control applied to the lighting device to the control sections.

8. The system according to claim 5, wherein
the control apparatus further includes a plurality of input sections to which a predetermined voltage is applied, and
the specifying section specifies, according to a value of the voltage applied to the input sections or a combination of the input sections applied with the voltage, the control system corresponding to the control signal received by the receiving section.

9. The system according to claim 5, wherein the specifying section includes a specifying mode for specifying a control system and specifies, only when the specifying mode is effective, a control system corresponding to the control signal received by the receiving section.

10. A control method for performing control according to a control signal received from a host apparatus, the method comprising:
specifying a control system corresponding to the received control signal;
deriving control designated by the received control signal according to the specified control system; and
applying control derived at the deriving to a lighting device.

11. The method according to claim 10, further comprising:
generating a first signal obtained by subjecting the control signal to full-wave rectification and a second signal obtained by subjecting the control signal to half-wave rectification, wherein
the deriving is deriving control designated by the received control signal using one of the rectified first signal and the rectified second signal.

12. The method according to claim 10 or 11, wherein the specifying is specifying the control system corresponding to the received control signal according to a value of a voltage applied to a plurality of input sections to which a predetermined voltage is applied or a combination of the input sections applied with the voltage.

13. The method according to any one of claims 10 to 12, wherein the specifying is specifying the control system corresponding to the received control signal only when a specifying mode for specifying the control system is effective.
